(19) United States
(12) Patent Application Publication
(10) Pub. No.: US 2008/0048456 A1
(43) Pub. Date: Feb. 28, 2008

(54) MODULAR MICROTURBINE SYSTEM

(75) Inventors: Brian P. Browning, Montpelier, CT (US); Charles Maccini, Bath, NH (US); Deborah Gagne-Barney, Barre, VT (US); Robert Humphrey Rolland, Waitsfield, VT (US)

Correspondence Address: CANTOR COLBURN, LLP - PROTON, 20 Church Street, 22nd Floor, Hartford, CT, 06103, US

(73) Assignee: NORTHERN POWER SYSTEMS, INC., Waitsfield, VT (US)

(21) Appl. No.: 11/466,468

(22) Filed: Aug. 23, 2006

(51) Int. Cl. H02K 7/18; F02B 63/04

(52) U.S. Cl. 290/1 A

(57) ABSTRACT

An electrical power generation system for providing electrical power to a load is provided. The system includes a plurality of microturbine units, each microturbine unit having a combustion microturbine engine coupled to an electrical generator. The electrical generator includes a means for converting the rotational movement of the turbine engine into electrical power. A single power module electrically is connected to the load and physically separated from the plurality of generators. The power module has a number of components including an enclosure and a plurality of batteries within said enclosure. A plurality of generator controls is located within the enclosure where each of the generator controls is coupled to one of the plurality of generators. The enclosure also includes a plurality of AC power converters with each AC power converters coupled to one of the electrical generators. A plurality of DC to AC power converters is coupled to the plurality of batteries and a first electrical buss coupled to the plurality of AC power converters and the DC to AC power converters. Finally, a power distribution line is electrically coupled to the first electrical buss.

### FIELD OF INVENTION

This disclosure relates generally to a microturbine electrical power system and particularly to a modular electrical power system integrating an uninterruptible power supply and having the ability to add or remove generation capacity.

### BACKGROUND OF THE INVENTION

Distributed power generation systems are utilized in a number of circumstances. Commonly, these type of systems are used to provide for the localized power needs where traditional utility generated power is either unavailable or doesn't provide sufficient reliability or quality. In many applications, such as in the exploration of oil and gas, there is no electricity available to power the machinery necessary to complete the task at hand. To accommodate this, the use of small, modular, distributed generation microturbine units has increased steadily over time. The use of microturbine units allows the deployment and installation of electrical power systems virtually anywhere in the world.

These microturbine power generating units typically include a simple cycle turbine engine and an electrical generator. Each device in this unit has a rotating component such as the turbine blades or impeller, a turbine wheel and a permanent magnet rotor. The microturbine unit translates the rotational energy created through the burning of a hydrocarbon fuel into electrical power.

In harsh applications, such as on an oil platform, a hazardous environment may exist which requires equipment be appropriately designed to operate in that environment. For example, it is usually required that equipment be designed to comply with the National Fire Protection Administration (“NFPA”), Class 1, Division 2 (“C1D2”) rating. Since the microturbine units were typically packaged with all the batteries, power conversion and control electronics, along with heat recovery and exhaust management the microturbines needed to be C1D2 compliant as well. By packaging as an integrated C1D2 unit, the microturbine units while still being field deployable to remote locations, tended to be large and expensive to produce. Due to the size, and need for periodic maintenance of microturbine unit and its ancillary components, the operator was limited in placement of the microturbine unit. Additionally, as the load requirements of the application increased, the operator may be constrained by the available space. In applications such as oil and gas applications, where space is at a premium, this could dramatically increase the cost of ownership for operators.

Thus, there exists an unsatisfied need in the industry for an improved means of deploying a cost effective, easily scalable, electrical power system in harsh environments where the generation units may be physically separated from a single power control and distribution unit.

### SUMMARY OF THE INVENTION

An electrical power generation system for providing electrical power to a load is provided having a plurality of microturbine units. Each of the microturbine units having a combustion microturbine engine coupled to an electrical generator. The electrical generator includes a means for converting the rotational movement of the turbine engine into electrical power. A single power module is electrically connected to the load and is physically separated from the plurality of generators. The power module has a number of components including an enclosure and a plurality of batteries within the enclosure. A plurality of generator controls is located within the enclosure where each of the generator controls is electrically coupled to one of the plurality of generators. The enclosure also includes a plurality of AC power converters with each AC power converter coupled to one of the electrical generators. A plurality of DC to AC power converters is coupled to the plurality of batteries. A first electrical buss is coupled between the plurality of AC power converters and the DC to AC power converters. Finally, a power distribution line is electrically coupled to the first electrical buss. The power module may also have a cabinet moveably mounted to rails. The rails are mounted between the sides of the power module enclosure.

A microturbine is also provided having an enclosure with a single inlet and a first and second exhaust port. A microturbine engine is located within the enclosure where the microturbine engine has an air intake and an outlet. The outlet is coupled to the first exhaust port. Finally, a ventilation system is located within the enclosure having a first portion coupled between the enclosure inlet and the microturbine inlet, and a second portion coupled between the enclosure inlet and the second exhaust port. Finally, the ventilation second portion further includes a fan and a heat exchanger. The heat exchanger is coupled to the microturbine engine and the fan is arranged to direct air from the enclosure inlet through the heat exchanger.

Also, a microturbine system for providing electricity to an end load is provided that includes a support structure having a plurality of shelves. A plurality of microturbines is removably mounted to the support structure wherein each of the plurality of microturbines includes means for being removed from the support structure independently from each of the other plurality of microturbines. A power module spaced apart from the support structure is provided that is electrically coupled to the plurality of microturbines. The power module includes a first common AC electrical buss electrically coupled to the plurality of microturbines. An uninterruptible power supply having a DC electrical buss is provided in the power module that is electrically coupled to the AC electrical buss, and a first and second electrical power distribution line. The first electrical power distribution line is electrically coupled to the AC electrical buss and the second electrical power distribution line is electrically coupled to the DC electrical buss.

The above discussed and other features will be appreciated and understood by those skilled in the art from the following detailed description and drawings.

### BRIEF DESCRIPTION OF THE DRAWINGS

Referring now to the drawings, which are meant to be exemplary and not limiting, and wherein like elements are numbered alike:

FIG. 1 is a perspective view illustrating an exemplary embodiment modular microturbine electrical power system;

FIG. 2 is a perspective view of the exhaust side of the microturbine unit of FIG. 1;

FIG. 3 is a perspective view of the inlet side of the microturbine unit of FIG. 1;

FIG. 4 is a perspective view of the exploded microturbine unit of FIG. 1

FIG. 5 is perspective view of a plurality of rack mounted microturbine units of FIG. 1;

FIG. 6 is a plan view illustrating the layout of the power control system of FIG. 1;

FIG. 7 is side view, partially in section, illustrating the major components of the microturbine unit of FIG. 1;

FIG. 8 is side view, partially in section, illustrating the ventilation air paths of the microturbine unit of FIG. 1;

FIG. 9 is a side view, partially in section illustrating the power control system of FIG. 1;

FIG. 10 is a perspective view of an exemplary embodiment microturbine power control and conversion cabinet; and,

FIG. 11 is an electrical schematic diagram of the modular microturbine electrical power system of FIG. 1.

### DESCRIPTION OF PREFERRED EMBODIMENT

Generation of electrical power in remote location may be accomplished by many different methods. A method uses a simple cycle microturbine where a hydrocarbon fuel, such as natural gas, is burned in a combustor causing the air within the combustor to expand. The expanding air is used to rotate a turbine wheel to produce rotational energy. The rotational energy drives an electrical generator to create electrical power. While these common methods are very efficient, they also have undesired effects in that the ancillary equipment needed to control the operation and condition the electrical power need to be shielded from the high temperatures generated by the microturbine. Further, such systems can be difficult to scale as the needs of the application increase and require additional capacity. One alternate method of creating electrical power using a plurality of microturbines is to separate the microturbine from the ancillary equipment, such as the power controls, power conditioning and uninterruptible power supply devices, to provide the operator the maximum flexibility in placement of the equipment while reducing the environmental strain on the ancillary equipment.

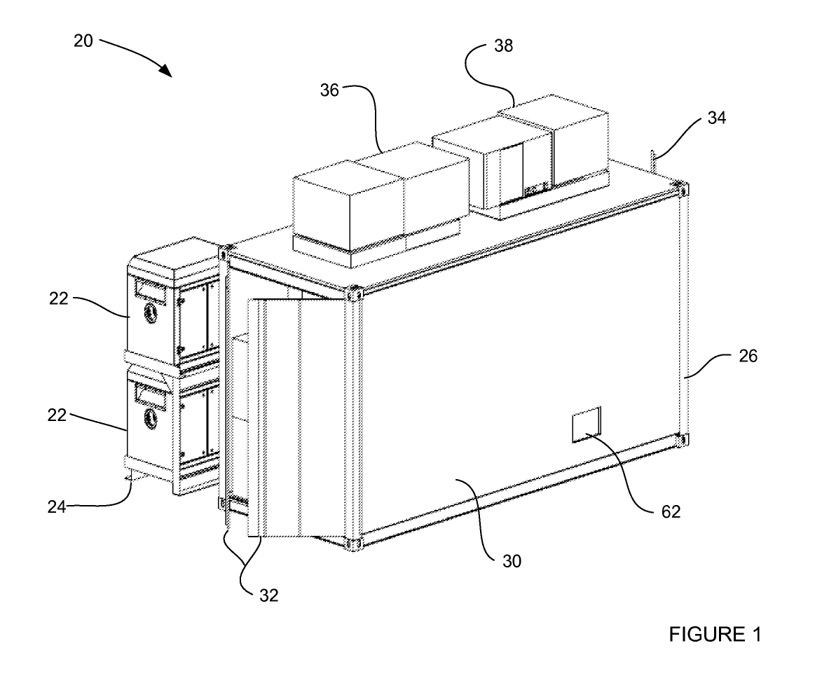

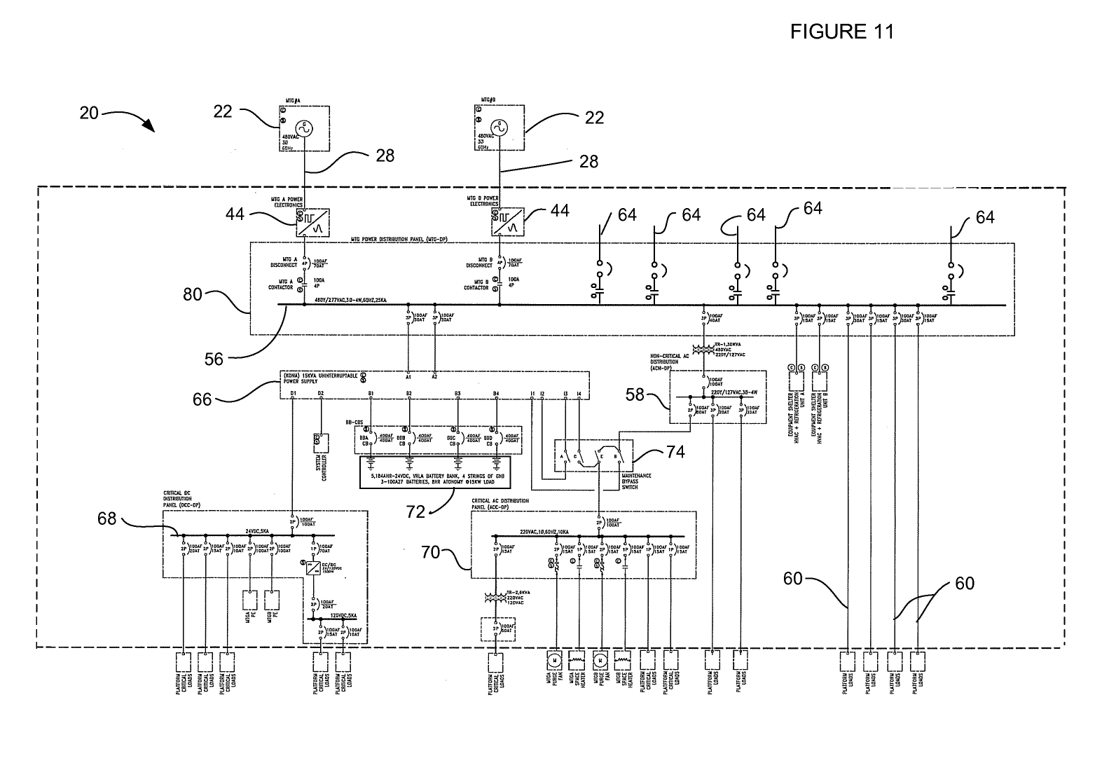

Referring to FIG. 1 and FIG. 11, a microturbine electrical power generation system 20 capable of generating electrical power is shown. In the exemplary embodiment, the system 20 generates electrical power in the range from 0 kW to 500 kW. The microturbine system 20 includes a plurality of microturbine units 22 which are mounted to a support racking arrangement 24. In the exemplary embodiment, each microturbine unit 22 generates approximately 40 kW of three-phase AC electric power, at 800 V, 2000 Hz. The microturbine units 22 are electrically coupled by line 28 to a power power module 26. It should be appreciated that while the microturbine units 22 are illustrated as being adjacent to the power module 26, this is done for the sake clarity only and not intended to be a limitation. As will be described in more detail herein, it is contemplated that the microturbine units 22 may be positioned up to at least 30 feet to 150 feet from the power converters 44 located in the power module 26 without need for additional equipment or electrical conditioning.

In the exemplary embodiment, the power module 26 is includes an enclosure 30 having doors 32, 34 at each end to provide the operator access to the interior of the power module 26 as may be needed from time to time to perform maintenance or upgrade activities. The enclosure may be manufactured from any suitable material, such as but not limited to stainless steel, carbon steel, aluminum or any combination thereof. In the exemplary embodiment, the enclosure 30 is an ISO container, or isotainer, that is 20 ft in length, 8 ft wide and 8 ft-6″ high. Depending on the location of the system 20, one or more environment control units 36, 38 may be located on with the top or side portions of the enclosure 30. The environmental control units 36, 38 may include, but are not limited to devices such as air conditioners, heaters, air filters and the like. Environmental control units 36, 38 may further provide pressurization of the enclosure 30. The pressurization creates an air pressure within the enclosure 30 that is greater than the air pressure of the environment surrounding the module 26 allowing the maintaining of an NFPA Class 1, Division 2 rating within the enclosure 30. The environmental control units 36, 38 may further provide the conditioning functionality needed to maintain the appropriate operating environment within the power module 26.

Power line 28 from each microturbine unit 22 enters the power module 26 through a pass-through 40 in the enclosure 30. In addition to electrical power conductors, power line 28 also includes a communication cable to allow signals to be transferred between the microturbine units 22 and the microturbine controller 42. Power line 28 terminates at one of the power converters 44. Power converters 44 may be a traditional IGBT type rectifier, or may optionally be a power converter such as that described in U.S. Pat. No. 6,693,409 entitled “Control system for a power converter and method of controlling operation of a power converter” which is incorporated herein by reference. The use of the optional power converter described in the '409 patent eliminates the need for a high speed/reliable communications link 46 to accomplish the synchronization of the AC waveform created by the power converters 44. In the exemplary embodiment, the power converters 44 alters the operating characteristics of the raw electrical power produced by the microturbine units 22 and converts them to have a second set of characteristics, preferably 480 VAC, 0 kW-40 kW, 60 Hz.

The controller 42 controls the microturbine unit 22 speed by controlling the amount of fuel provided to the microturbine generator 110. The controller 42 uses sensor signals generated by sensors (not shown) within the microturbine unit 22. The sensors include speed sensors and various temperature and pressure sensors for measuring operating parameters in the microturbine unit 22.

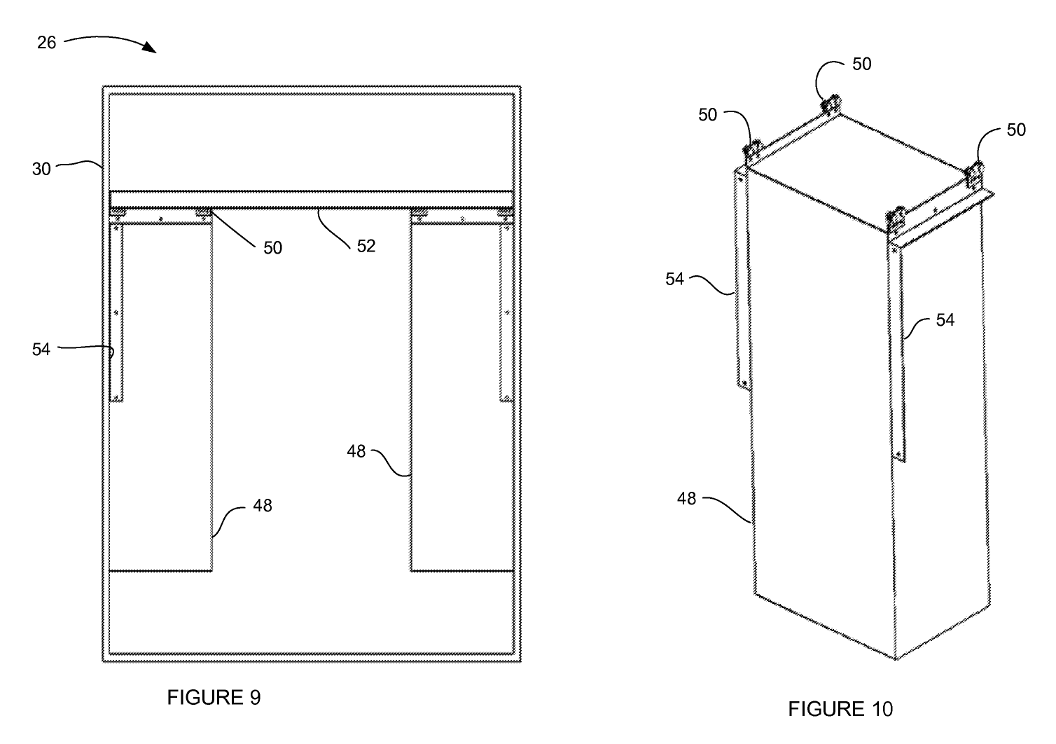

The power converters 44 and controllers 42 are mounted in a control and conversion cabinet 48 (FIG. 9 and FIG. 10). The cabinet 48 includes rollers 50 that rest in a rail 52 which extends between the two walls of the power module 26. The rollers allow the cabinet 48 to be moved from an operating position against the wall of the enclosure 30 towards the center of the power module 26 allowing access to the rear connections on the converters 44 and controller 42. A flange 54 extends from one side of the cabinet 48 to allow the cabinet to be fixed to the wall with a bolt (not shown) during operation. Mounting the cabinet 48 and allowing it to be easily and quickly moved provides additional advantages to the operator. The converter 44 and controller 42 typically have connections and maintenance required on both sides of the devices. Due to the narrow width of the power module 26, there typically isn't sufficient room to allow the cabinets to be mounted to allow access on all sides. By moveably mounting the cabinet, the operator and quickly service the components in the cabinet with minimal difficulty.

The electrical power leaves the power converters 44 and flows into the common AC buss 56 located in the distribution cabinet 80. From this point, the electricity can flow through one or more distribution lines 60 to the end loads (not shown). In the exemplary embodiment, each of the electrical power distribution lines 60 transfer electrical power having electrical characteristics of three phase 480 VAC, 60 Hz. Distribution line 60 exits the power module 26 through a pass-through 62 in the wall of the enclosure 30. AC buss 56 includes one or more additional connectors 64. The connectors 64 allow the scaling of the system 20 to increase the electrical generation capacity as the number of end loads increase. To add additional microturbine units 22 to the system 20, only a power converter 44, controller 42 and power line 28 need to be installed in the power module 26. No other configuration or hardware or distribution system components need to be altered or changed.

The electricity from AC Buss 56 also couples to uninterruptible power supply 66 (“UPS”) which provides further distribution of the generated electrical power via critical DC distribution panel 68 and critical AC distribution panel 70. In the exemplary embodiment, the DC distribution panel 68 will provide electrical power with the electrical characteristics of 24 VDC while the AC distribution panel 70 will provide electricity at 220 VAC, 60 Hz. UPS 66 also provides the interconnection point with the battery banks 72 through a common DC buss arrangement. Battery banks 72 include a plurality of wet-type lead acid type batteries arranged in parallel to provide DC electric power. In the exemplary embodiment, the batteries are a valve regulated lead acid (“VRLA”) type such as that manufactured by GNB Industrial Power sold under the tradename ABSOLUTE-2P. Alternatively, other battery types such as but not limited to absorbed glass mat, nickel-cadmium (NiCd), nickel metal hydride (NiMH), and lithium-ion (Li-Ion) type cells may be used.

The UPS 66 further includes rectifiers and inverters that are well known in the art to allow DC and AC power to flow through distribution panels 68, 70 from either the AC buss 56 or the battery banks 72. In the exemplary embodiment, the rectifiers are a switched mode type rectifier such as that manufactured by Argus Technologies under the tradename CORDEX, while the inverters are an IGBT type inverter such as that manufactured by CE+T Digital Power Solutions under the tradename RDI. As used herein, the term “critical load” refers to loads that the operator needs to keep powered even if the microturbine units 22 are not operating. Further, the term “critical” does not refer to a needed or required element of the invention and is not intended to be limiting. Thus the UPS 66 is arranged to automatically flow power from the electrical generation sources from the microturbine units 22 to the battery banks 72 in the event power ceases to flow from the microturbine units 22. Further, UPS 66 includes a battery charging circuit (not shown) that utilizes the electricity generated by the microturbine units 22 to re-charge the battery banks 72 once the microturbines restart operation.

A noncritical AC distribution panel 58 distributes electricity to loads that are of lower criticality to the operator. Panel 58 also connects to the critical AC distribution panel 70 via a maintenance bypass switch 74. The bypass switch provides the operator with the advantage of continuing to operate the loads even during periods when the UPS 66 is in need of maintenance or repair.

Power module 26 will also include additional electrical distribution equipment that is know in the art, such as but not limited to circuit breakers, fuses, transformers and relays as needed to provide an appropriate operating system. A fire suppression system 76 may optionally be included to prevent damage related to an incendiary event. In the exemplary embodiment, the suppression system 76 includes carbon dioxide cylinders that provide the extinguishing means. A system controller 78 is provided to operate the necessary control functionality of the system 20 such as the environmental control units 38, the monitoring of suppression system 76 along with any other functionality such as communications with a central operator control room.

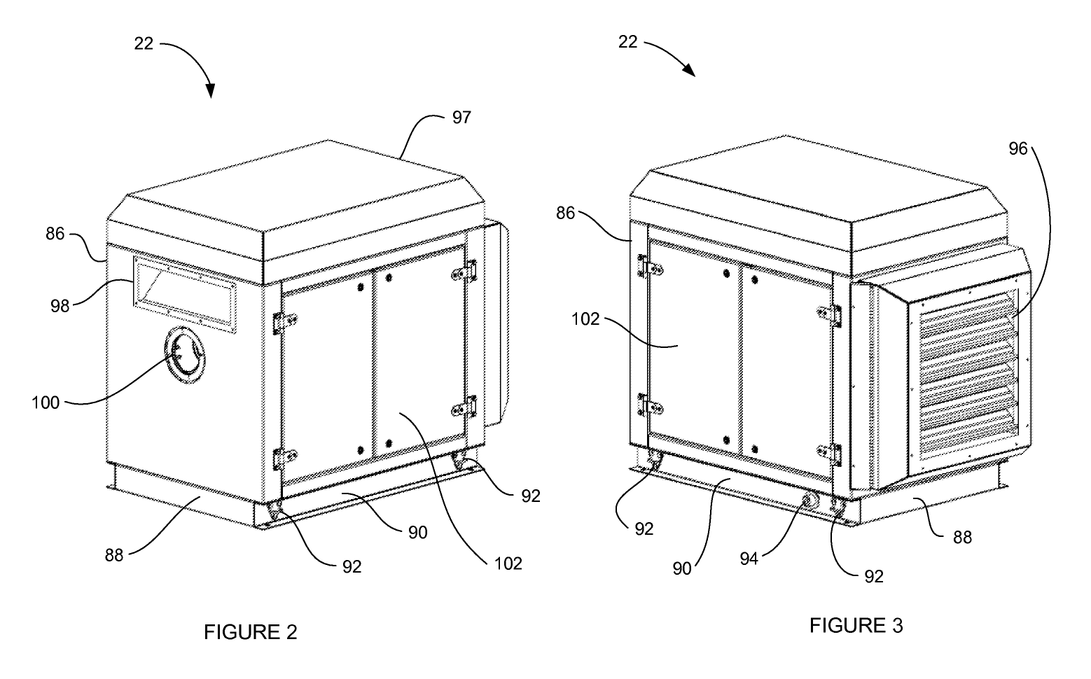

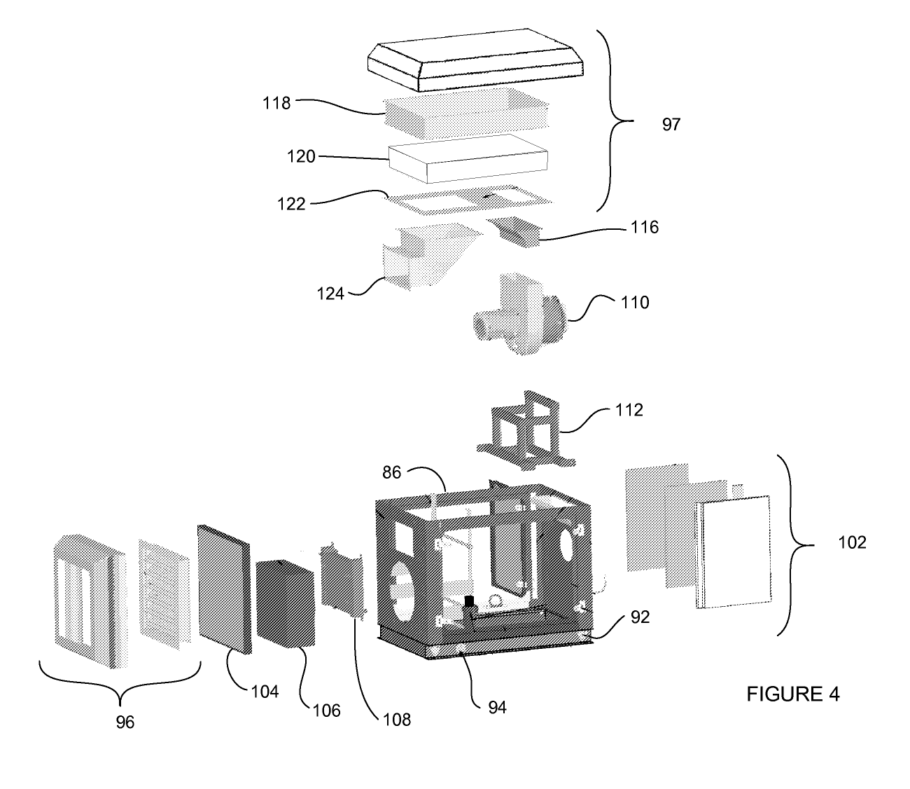

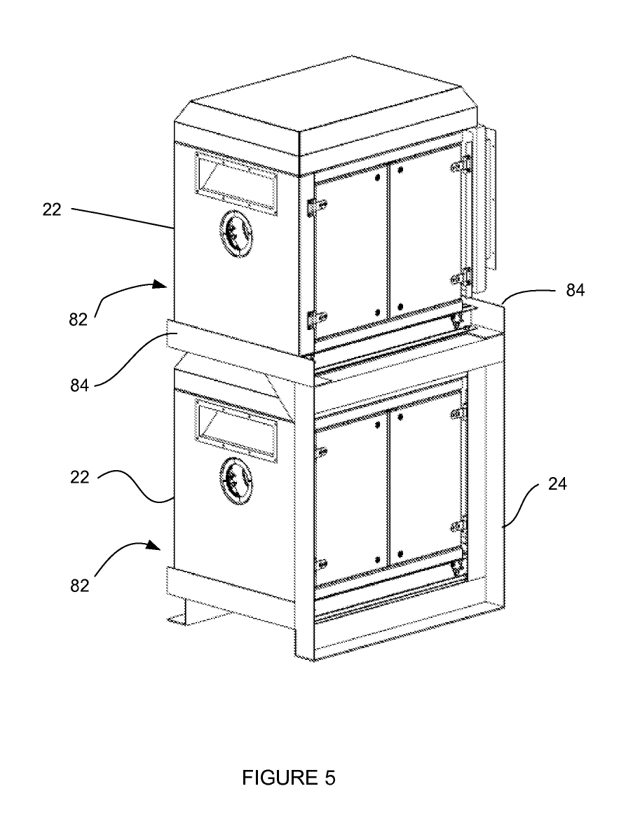

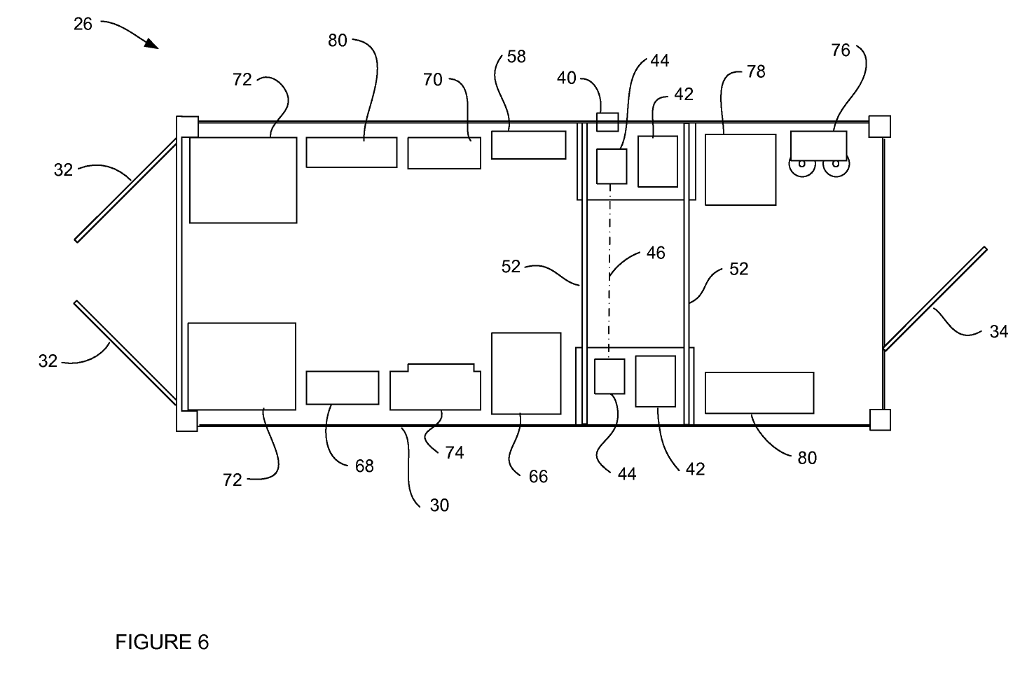

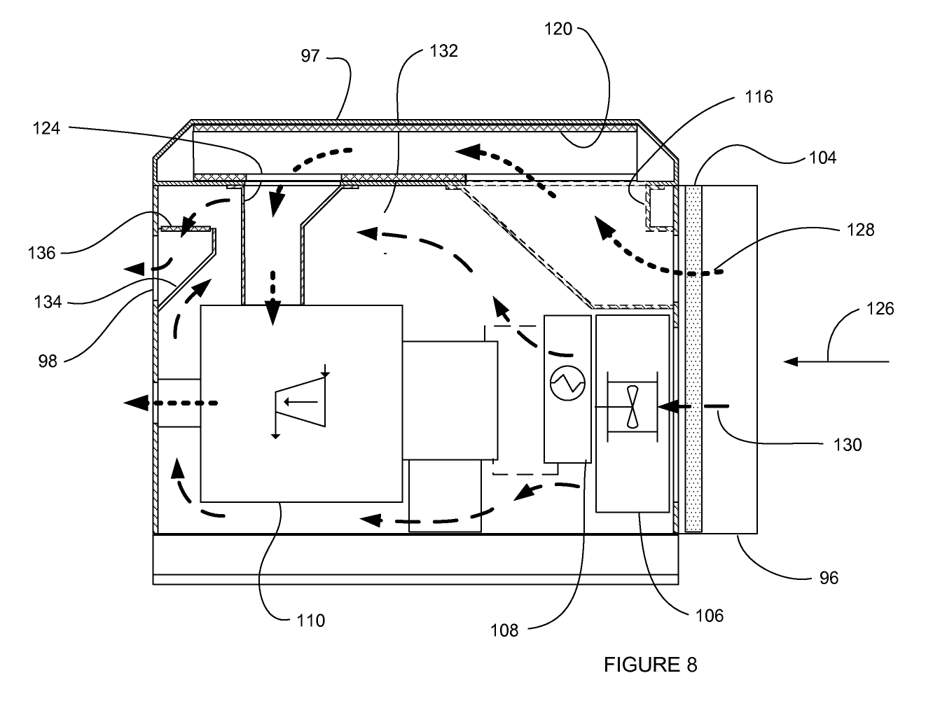

Referring now to FIGS. 2-5 and FIGS. 7-8, the microturbine unit will be described. As described above, the microturbine unit 22 is physically separate from the power module 26. It is expected that the microturbine unit 22 may be placed between 0 feet to 150 feet away from the power module 26 before the voltage magnification in the power line 28 exceeds the insulation ratings of the power line 28. Preferably, the microturbine units will be spaced a distance between 30 feet and 100 feet from the power converter 44 to minimize any other effects, such as heat, on the power module 26. The support structure 24 includes a plurality of shelves 82 for the operation of microturbine units 22. In the exemplary embodiment, the shelves 82 include a pair of arms 84 that support the bottom of each microturbine unit 22. The support structure 24 may be made from any suitable material, including, but not limited to stainless steel, carbon steel, aluminum, titanium or the like.

The support structure 24 may accommodate any number of microturbine units 22. As described above, to increase the capacity of the system 20, only the additional microturbine unit 22 along with its associated control 42 and power converter 44 are necessary to scale the system 20 for additional capacity. Additionally, it is contemplated that by arranging the microturbine units on shelves, the operation of the individual units 22 may be temporarily halted to allow removal, repair, maintenance or replacement without interrupting the operation of surrounding microturbine units. This provides numerous advantages to the operator in terms of redundancy, ease of planning maintenance periods and also may allow a reduction in the sizing of the battery banks 72.

The microturbine unit 22 includes an enclosure 86 is mounted to a bottom plate 88. The bottom plate has a pair of channels 90 to which are mounted d-rings 92 and a fuel bulkhead connector 94. The d-rings 92 provide a point for the operator to facilitate handling of the microturbine unit 22 during installation and servicing. The microturbine unit 22 further includes an inlet louver 96 and a pair of exhaust ports 98, 100. In the exemplary embodiment, the inlet louver 96 is mounted to the outside of the enclosure 86. As will be discussed below in more detail a top portion 97 forms part of the ventilation duct for providing combustion air to the microturbine. Finally, a pair of doors 102 on each side of the microturbine unit 22 provide access to the interior of the enclosure 86 to facilitate servicing and maintenance of the microturbine unit 22.

In the exemplary embodiment, the enclosure 86 meets the requirements of National Fire Protection Association Section 496 “Standard for Purged and Pressurized Enclosures for Electrical Equipment.” The enclosure may meet the purging and pressurization requirements specified for a Class 1, Division 2 environment. Alternatively, the enclosure 86 may not meet these requirements when the system 20 is to be installed in applications where volatile flammable liquids or flammable gases are handled, processed, or used.

An air filter 104 is mounted within the inlet louver 96 to remove particulate, salt and mist from the air stream prior to entering the enclosure 86. Adjacent to the air filter 104, a fan 106 is mounted to the inside of the enclosure 86 and is arranged to flow air from the inlet louver 96 over a radiator 108. The radiator 108 is fluidly coupled via lines 114 to remove heat from the microturbine generator 110 lubricating oil. In the exemplary embodiment, the microturbine generator 110 is a simple cycle microturbine that utilizes natural gas as a fuel. The microturbine generator 110 includes both a combustion turbine and an electrical alternator portion. A frame 112 supports the microturbine generator 110 within the enclosure 86. The frame 112 further includes a means for attaching a removal device, such as but not limited to a hoist, a pallet jack or a fork lift, to allow removal of the microturbine generator 110. The electrical alternator may be any known type of generator that converts mechanical energy into electricity through electromagnetic induction, such as but not limited to a permanent magnet alternator. The power line 28 exits the microturbine unit 22 through the channel 90.

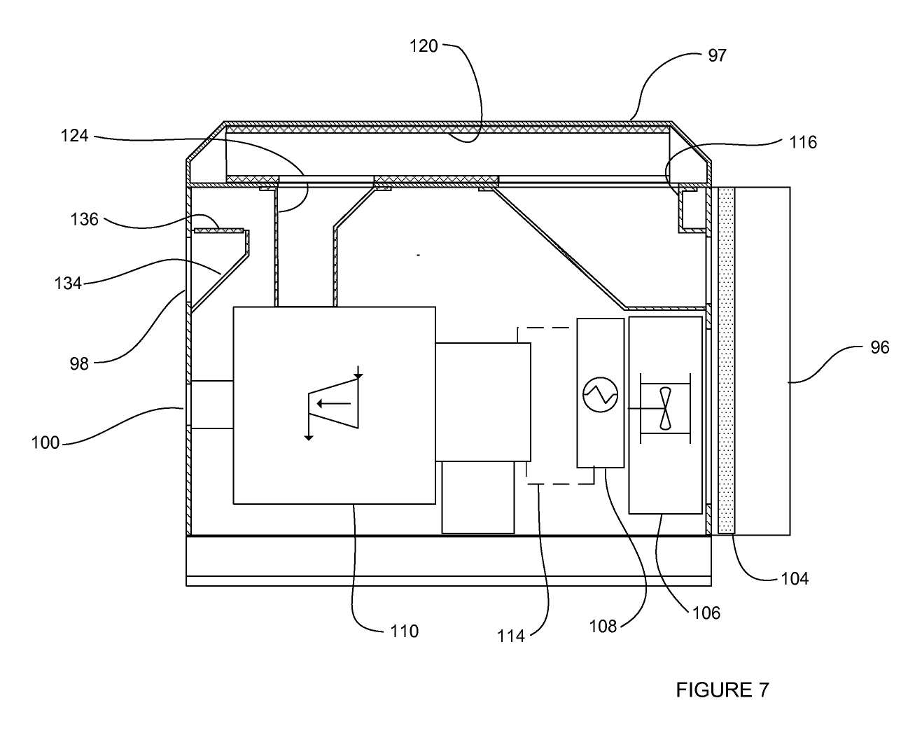

An air stream 126 is pulled into the microturbine unit 22 by both the fan 106 and the microturbine generator 110. After entering through the inlet louver 96, the air stream is bifurcated into first and second air stream 128, 130. The first air stream 128 is drawn through an intake duct 116 and through an intake plenum plate 122 into the top portion 97. The top portion may include a number of additional components such as an intake plenum 118 and an insulation box 120. The plenum 118 and insulation 120 are arranged to direct the air stream and also dampen and attenuate any sound that may be created by the microturbine generator 110. The insulation box 120 includes a sheet of insulation arranged on the top and bottom of the box 120 (FIG. 7). The insulation box 120 further includes openings in the bottom sheet to allow air stream 128 to enter and exit the box 120. The air stream 128 is directed back through a second hole in the plenum plate 122 and through engine duct 124 and into the microturbine generator 110.

The microturbine generator 110 mixes the first air stream with fuel and burns the mixture to produce rotational energy as described herein above. The exhaust remains of the burned mixture exit the microturbine generator 110 through exhaust port 100. In the exemplary embodiment, an exhaust duct (not shown) will be coupled to the exhaust port 100 to direct the exhaust stream to a location desired by the operator. Alternatively, the operator may suitable arrange the location of the generator unit 22, for example at the edge of an oil platform, to allow the exhaust stream to enter atmosphere at port 100.

A second air stream 130 is created from the inlet air stream 126 by fan 106. The second air stream enters the interior 132 of the enclosure 86 after passing through fan 106 and radiator 108. As described above, radiator 108 receives a hot lubricating oil from the microturbine generator 110. As the second air stream 130 passes through the radiator 108, the heat from the lubricating oil is removed, lowering the temperature of the lubricant oil before it re-enters the microturbine generator 110. After exiting the radiator 108, the second air stream 130 passes through the interior 132 flowing around the microturbine generator 110 and any associated components (not shown). Additional heat from the microturbine generator 110 and associated components will transfer to the second air stream 130 before the air stream 130 exits the enclosure 86 through exhaust duct 134 and exhaust port 98. A screen 136 covers the exhaust duct 134 to prevent rain and insects from entering the interior 132. By routing the air through the interior 132, the microturbine unit components are maintained at appropriate operating conditions and pressurization specifications of NFPA Class 1, Division 2 standards. Additionally, by arranging the second air stream 130 to enter near the bottom of the interior 86 and the exhaust duct 134 near the top, the ventilation will be further assisted by the natural convection created by the heat generated from the turbine generator 110 and associated components.

While the invention has been described with reference to a preferred embodiment, it will be understood by those skilled in the art that various changes may be made and equivalents may be substituted for elements thereof without departing from the scope of the invention. In addition, may modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. An electrical power generation system for providing electrical power to a load, said power generation system comprising:
a plurality of microturbine units, each microturbine unit having a combustion microturbine engine coupled to an electrical generator, said electrical generator including means for converting the rotational movement of said turbine engine into electrical power;
a single power module electrically connected to said load and physically separated from said plurality of generators, wherein said power module includes:
an enclosure;
a plurality of batteries within said enclosure;
a plurality of generator controls, each of said generator controls being coupled to one of said plurality of generators;
a plurality of AC power converters, each of said AC power converters coupled to one of said electrical generators;
a plurality of DC to AC power converters coupled to said plurality of batteries;
a first electrical buss coupled to said plurality of AC power converters and said DC to AC power converters; and,
a power distribution line coupled to said first electrical buss.

2. The electrical power generation of claim 1 wherein said plurality of microturbine units is physically separated from said power module by a distance greater than 30 feet.

3. The electrical power generation system of claim 2 wherein said plurality of microturbine units is physically separated from said power module be a distance between 30 feet and 150 feet.

4. The electrical power generation of claim 2 wherein said enclosure further includes a cabinet wherein at least one of said plurality of generator controls and at least one of said AC power converters is mounted to said cabinet.

5. The electrical power generation system of claim 4 wherein said power module further includes a pair of rails coupled to said enclosure wherein said cabinet is movably mounted to said rails.

6. The electrical power generation system of claim 5 wherein said plurality of AC power converters are coupled to second electrical buss, said second electrical buss being electrically coupled between said plurality of AC power converters and said first electrical buss.

7. The electrical power generation system of claim 6 further comprising an AC distribution panel electrically coupled between said first electrical buss and said power distribution line.

8. The electrical power generation system of claim 7 further comprising an uninterruptible power system that includes said plurality of DC to AC power converters and a means for receiving power from said batteries and means for providing electrical power to said batteries.

9. A microturbine comprising:
an enclosure, said enclosure having a single inlet and a first and second exhaust port;
a microturbine engine within said enclosure, said microturbine engine having an air intake and an outlet, said outlet being coupled to said first exhaust port; and,
a ventilation system within said enclosure, said ventilation system including a first portion coupled between said enclosure inlet and said microturbine inlet, and a second portion coupled between said enclosure inlet and said second exhaust port.

10. The microturbine of claim 9 wherein said ventilation second portion further includes a fan and a heat exchanger, said heat exchanger is coupled to said microturbine engine and said fan is arranged to direct air from said enclosure inlet through said heat exchanger.

11. The microturbine of claim 10 wherein said enclosure includes a top portion and an interior portion, wherein said microturbine engine is mounted in said interior portion.

12. The microturbine of claim 11 further comprising an air filter mounted adjacent to said single inlet.

13. The microturbine of claim 12 further comprising a louver mounted to said enclosure adjacent said inlet, wherein said air filter is arranged within said louver.

14. The microturbine of claim 9 further comprising insulation mounted within said ventilation first portion wherein said insulation attenuates sound generated with said enclosure.

15. A microturbine system for providing electricity to an end load, said microturbine system comprising:
a support structure having a plurality of shelves;
a plurality of microturbines removably mounted to said support structure wherein each of said plurality of microturbines includes means for being removed from said support structure independently from other of the said plurality of microturbines;
a power module spaced apart from said support structure, said power module being electrically coupled to said plurality of microturbines, said power module including a first common AC electrical buss, said buss being electrically coupled to said plurality of microturbines, an uninterruptible power supply having a DC electrical buss electrically coupled to said AC electrical buss, and first and second electrical power distribution lines wherein said first power distribution line is electrically coupled to said AC electrical buss and said second power distribution line is electrically coupled to said uninterruptible power supply.

16. The microturbine system of claim 15 wherein said power module includes:
a means for receiving AC electrical power having a first characteristic from said plurality of microturbines;
a means for converting said AC electric power to have a second characteristic, said AC converting means being coupled to said common AC electrical buss.

17. The microturbine system of claim 16 wherein said uninterruptible power supply includes a means for converting said AC electric power from said common AC buss into DC electric power wherein said means for converting said AC electric power to DC electric power is coupled to said second power distribution line.

18. The microturbine system of claim 17 further comprising an environmental conditioner device mounted to said power module and electrically coupled to said common AC buss.

19. The microturbine system of claim 18 wherein said environmental conditioner device pressurizes said power module wherein the air pressure within said power module is greater than the pressure outside said power module.

20. The microturbine system of claim 18 further comprising a battery bank electrically coupled to said means for converting said DC electric power.
